(19) United States
(12) Patent Application Publication
(10) Pub. No.: US 2018/0189867 A1
(43) Pub. Date: Jul. 5, 2018

(54) NETWORK AUCTION METHOD AND SYSTEM FOR ESTABLISHING A BIDDING REWARD MECHANISM

(71) Applicant: Gang Hu, Changsha (CN)

(72) Inventor: Gang Hu, Changsha (CN)

(21) Appl. No.: 15/570,322

(22) PCT Filed: May 12, 2015
(86) PCT No.: PCT/CN2015/078734

§ 371 Date: Oct. 27, 2017

(30) Foreign Application Priority Data
Apr. 28, 2015 (CN) 2015102073764

(51) Int. Cl. G06Q 30/08; H04L 29/08; G06F 17/30

(52) U.S. Cl. CPC G06Q 30/08; G06F 17/30864; H04L 67/02

(57) ABSTRACT

A network auction method and system for establishing a bidding reward mechanism, the bidding reward mechanism is as follows: a principal entrusts an auctioneer to reward bidders so as to enable the bidders to enjoy part of price difference within a bidding increment; and in an auction, an auction platform freezes margin which is equal to or accounts for a certain proportion amount of bidding of one bidder every time the bidder bids, the frozen margin is unfrozen only until a new auctioneer bids, and so on. The method and system realize transparency and rigorousness, security and reliability, openness, impartiality and fairness, and can activate an auction market and serve the public and economy.

### CROSS REFERENCE TO RELATED APPLICATIONS

This application is a U.S. National Phase application under 35 USC § 371 of International Application No. PCT/CN2015/078734 filed May 12, 2015 which claims priority from Chinese Patent Application No. CN 2015102073764 filed Apr. 28, 2015. The entire contents of these applications are hereby incorporated herein by reference.

### TECHNICAL FIELD

The present invention belongs to the technical field of e-commerce, and in particular to a network auction method and system for establishing a bidding reward mechanism.

### BACKGROUND ART

According to the law, auction refers to the buying and selling form through which designated articles or property rights are transferred, in the form of public bidding, to those providing the highest bidding price. Auction activity shall abide by relevant laws and administrative decrees, and follow the principle of openness, fairness, impartiality, honesty and credibility.

If there is no bidder, there is no buyer, and the final hammer price is not produced without the bidding behavior of the bidder. Each round of bidding behaviors of all bidders who participate in the bidding process eventually results in the hammer price and the buyer. That is to say, the bidding behavior of the bidder plays an indispensable role in achieving the hammer price of the auction target. Relative to the stock trading system, the buying and selling behavior is accomplished by the buying and selling of a party. The system in the present invention is different, and we can consider the valid bidding behavior of the bidder as buying, and the valid bidding behavior of a new bidder is considered as helping the selling of the previous bidder and accomplishing his own buying at the same time.

It is required by the Auction Law of the People's Republic of China that once the bidding price is announced, a bidder shall not withdraw it. That is to say, each bidding behavior, with the bidding price exceeding the auction reserve price, of the bidder may make himself a buyer, if other bidders no longer increase the price. Of course, the other bidders have the right to increase the price until they become the bidder whose bidding price is the highest. The principle that the highest-price-offer wins the auction target is fair to all the bidders who participate in the bidding. The price bidding or price adding of the bidder and the price bidding or price adding of the new bidder can be regarded as a relatively complete bargaining behavior, because the price bidding or price adding of the new bidder is performed on the basis of the price bidding or price adding of the previous bidder, and actually the previous bidder temporarily serves as a seller.

In the traditional auction activities, since the bidders do not bear the bidding risk and cannot obtain the price difference caused by increasing the hammer price, the auction process can be manually manipulated easily, and it is prone to false transactions and malicious collusion between principals and auctioneers, between bidders and bidders and between bidders and auctioneers, thereby damaging the interests of others and breaking the principle of honesty and credibility.

In order to avoid this situation and ensure really open, fair and impartial auction activities, it is necessary to make technological innovation to the traditional auction activities.

### CONTENTS OF INVENTION

The technical problem to be solved by the present invention is to solve the above-mentioned problems in the prior art, and to provide a network auction method and system for establishing a bidding reward mechanism. By the adoption of the network auction system, the auction activities are more transparent, errors are reduced, the security, reliability, openness, impartiality and fairness of the transaction are guaranteed, bidders are rewarded, the interests of the auction parties are maximized, the auction market is activated, the circulation is invigorated, and the economy is served.

The present invention adopts the following technical solution:

A network auction method for establishing a bidding reward mechanism, wherein the bidding reward mechanism is as follows: a principal entrusting an auctioneer to reward bidders so as to enable the bidders to enjoy part of price difference within a bidding increment; and in an auction, an auction platform freezes an equal amount or a certain proportion amount of margin of one bidder when the bidder bids every time, the frozen margin is unfrozen only until a new auctioneer bids, and so on.

In the above technical solution, the network auction method for establishing the bidding reward mechanism specifically comprises:

1) an online network auction system is adopted, the system is implemented by a B/S architecture and is divided into a client and a server, the client comprises a Point of sales terminal, an auction website, a handheld terminal and an electronic display screen, and the server comprises a auction system background server, and a Bank card settlement system, a short message platform and a database, which are connected with the auction system background server; data is transmitted between the client and the server through the network by using an HTTPS protocol;
2) according to the law, the server formulates auction rules and an access system of parties involved in auction, signs agreements between an auctioneer and a principal and between the auctioneer and a bidder, and stores the agreements and the identity information of the principal and the bidder in a database;
the principal applies for a user name and a password through the auction system for checking the transaction condition and reward information of an auction target. The bidder applies for a user name and a password through the auction system for viewing the auction target, knowing the auction situation and participating in the auction;
the auction rules formulated by the server, the agreement signed between the auctioneer and the principal and between the auctioneer and the bidder comprise the bidding reward mechanism: after the completion of the auction of each auction target, the principal entrusts the auctioneer to reward the bidder with premium exceeding an auction reserve price in an hammer price of the auction target according to a certain proportion;
3) the auctioneer releases auction target information, the bidding reward mechanism, the auction time, an auction location, an auction target display manner, an auction target reserve price, a notary organ and other information to the client through the server and the network according to the agreement signed between the principal and the auctioneer, and meanwhile sends auction target bidding information to the bidder in the form of a short message through the short message platform;
4) the bidder can pay a full amount of auction margin to the auction platform through the auction website, or the handheld terminal, or the Bank card settlement system or customer service staff of authorized server within a prescribed time before the start of an auction, or the bidder can pay the auction margin in an auction process so as to guarantee the validity of each bidding of the bidder, and to guarantee that the bidder can pay the full amount of hammer price in time if the bidder becomes the buyer; the bidder obtains a corresponding amount of virtual chips after successfully paying sufficient auction margin;
when the bidder pays through the auction website or the handheld terminal, the auction website or the handheld terminal prompts the required payment to obtain the bidding permission and other information, bidder inputs user name, payment amount, bank card numbers, bank card passwords and other information in a browser form after confirmation, the client performs 3DES encryption on the information of the browser form and sends the information of the browser form to the auction system background server by using the https protocol, the background server obtains the user name, bank card number ciphertext, password ciphertex, payment amount ciphertext and other information by decrypting the information, then packages all the information into an IS08583 standard message, and sends a payment message to a Bank card settlement system background through a dedicated network of the Bank card settlement system background in the form of a socket message request, the Bank card settlement system background forwards the message to different banks through received bank card bin information and the dedicated networks with the banks to perform a deduction operation, and forwards a success message to the Bank card settlement system, after the deduction operation of the banks are complete, the Bank card settlement system sends the information to the auction system background server and transfers the corresponding amount to a public account of the auction platform through super online bank, the auction system background server inserts deduction information into the database after obtaining the information of successful deduction, authorizes corresponding bidding permission and an auction password to the bidder and then returns the permission information to the client, and the entire margin payment process is ended;
5) the auction is started, the whole process of the auction is displayed on the electronic display screen of the client, the handheld terminal and the page of the auction website, and the auction is carried out on the Internet and/or in an electronic trading hall; the electronic display screen is arranged in the electronic trading hall, the auction target is displayed on the electronic display screen, the handheld terminal and the auction website, after the auction is started, the bidder logs in the auction system and inputs the user name and the password, the browser transmits the ciphertext encrypted by the DES algorithm to the auction system background server through the https protocol, the auction system background server obtains plaintexts of the user name and the password after decrypting the received user name and the password, then inquires the database and compares the user name and the password with the user name and the password in the database, the auction system background server sends a login success command to a bidder browsing interface through the https after the verification is passed, the bidder enters an auction interface to perform a bidding operation, the auction is not limited by territory and can be operated on the Internet, the auction can also be implemented by a computer terminal of the electronic trading hall provided by the auction platform, if the auction is implemented in the electronic trading hall, the electronic display screen in the hall is directly controlled by the auction system background server for display, the latest record in the database is obtained by continuous refreshing, and thus the bidding information and the transaction information are updated and displayed in real time;
6) the bidder continuously performs local refreshing through a client browser to obtain the latest bidding information and transaction records in the database, the latest bidding information and the transaction records are displayed in the user auction interface in real time, the bidder starts to perform a bidding operation through the page operation if he feels that the price is appropriate, if the bidder clicks a “bidding” button on the interface, the system performs DES encryption on user information, the bidding amount and other information according to a preset price of the bidder and submits the information to the auction system background server by the AJAX local refreshing technology, at this time, the auction system background server is in a waiting state and waits for the bidding information of the clients in real time, after the auction system background server receives the first bidding information or the highest bidding information, the auction system background server obtain the information of the user who bids and the bidding amount through character strings parsing, and then performs rule verification on the bidding information, the auction system background server returns a bidding success message to all the online clients after the verification is passed, and all the clients comprising the client of the bidder display the message that the present bidding is successful;
7) every time the bidder bids, the auction platform firstly inquires the corresponding record of the bidder in the database, checks whether the user has corresponding auction margin for the auction operation, and freezes equal funds of bidding or a certain proportion of funds in the auction margin if the virtual chips are sufficient, and the frozen margin is unfrozen only until a new bidder starts bidding, and so on, and the bidder can obtain the bidding records of his own and other bidders from the auction interface in real time;
8) the auction system background server sets up an auction countdown, that is, there is a prescribed time after each bidding of the bidder, for example, the prescribed time can be set as 10 seconds, the electronic system whistles for three times to prompt that the prescribed time has been exceeded, the countdown is transferred to all the clients through the network in real time, if the server receives a certain valid bidding request, the countdown is reset to the initial value, if no bidding request is received when the countdown is ended, the system identifies the last valid bidding information as the transaction information, and then sends the transaction information to all the clients and terminals, and the bidding system temporarily closes the bidding and determines the buyer;
9) according to the bidding reward mechanism in the agreements signed between an auctioneer and a principal and between the auctioneer and a bidder, the auction system background server allocates the premium part exceeding the auction reserve price in the hammer price in proportions specified in the agreements to the bidders participating in the bidding in the auction of the auction target after the transaction of each auction target;
10) the auction interfaces of the client and the auction system background server display a transaction record of the bidding process and the information of the buyer, and display the reward amounts obtained by the bidders participating in the bidding; and
11) after the auction is ended, the buyer can pay the transaction amount of the auction and commissions through the website platform and fills in the receipt information and the like; the auction platform returns the auction margins and rewards of other bidders to the personal accounts of the bidders, and the bidders can transfer out balance of the accounts and can also deposit balance of the accounts in the personal accounts of the bidders to serve as the auction margins of the next auction.

According to the network auction method for establishing the bidding reward mechanism, the bidding reward mechanism is as follows: the reward limit is S, the total number of bidding is N, the reward obtained in each bidding is Mn (n=1, 2, . . . , N), the weight of each bidding is an (n=1, 2, . . . , N), Mn=S*an (n=1, 2, . . . , N), wherein

$$an = ( n * n ) / {\sum }_{i = 1}^{N} ( i * i ) ( n = 1 , 2 , . . . , N ) ,$$

the rule is open to all the users through the website, an administrator of the auction system background server adds the above algorithm to the system server.

According to the network auction method for establishing the bidding reward mechanism, wherein in the bidding reward mechanism, the bidder is rewarded according to a certain proportion of the premium part, the certain proportion is specified by the agreement signed between the principal and the auctioneer.

A network auction system for establishing a bidding reward mechanism, the system is implemented by a B/S architecture and is divided into a client and a server, and the client comprises a Point of sales terminal, an auction website, a handheld terminal and an electronic display screen; the server comprises an auction system background server, and a Bank card settlement system, a short message platform and a database, which are connected with the auction system background server; data is transmitted between the client and the server through the network by using an HTTPS protocol; the client mainly provides user registration, user browsing, auction target information check, auction participation and other functions, and meanwhile can provide bank card brushing, online deduction interface and electronic display screen functions; the server is mainly used for processing foreground data requests, interacting with the database and docking with the Bank card settlement system and the like; the system adopts a three-layer structural design, the electronic display screen, the auction website and the mobile phone terminal are display layers, Tomcst and JavaBeans are logical layers, the database, the Bank card settlement system and the short message platform are data layers, in the three-layer structure, the JSP is responsible for page layout, operation and display, the JavaBean is responsible for packaging service logic, and thus the maintainability and scalability of the system are improved; the system adopts the advanced AJAX technology to submit data without refreshing, thereby relieving the burden of the server and accelerating the submission speed, data transmission is implemented by using the HTTPS protocol which has the highest safety coefficient, key data are also encrypted and decrypted by using the 3DES algorithm, thereby having certain beneficial effects on the data confidentiality, data integrity and identity reliability; the system comprises: a user management module, an auction target management module, a bidding module, an agreement signing module, a display module, a payment interface module, a database management module, a system configuration module and a short message module; the system is further provided with a margin freezing and unfreezing module and a bidding reward module, the margin freezing and unfreezing module implements the following operations in an auction process: every time the bidder bids, the auction system platform firstly inquires the corresponding record of the bidder in the database, checks whether the user has corresponding virtual chips for the auction operation, and freezes chips, which is equal to or accounts for a certain proportion of bidding, in the virtual chips if the virtual chips are sufficient, and the frozen chips are unfrozen only until a new bidder starts bidding; and the bidding reward module implements the following operations: after the completion of the auction of each auction target, the principal entrusts the auctioneer to reward the bidder with the premium exceeding an auction reserve price in an hammer price of the auction target according to a proportion specified in the agreement.

The present invention has the following substantive distinguishing features and remarkable effects:

1. The method that the principal entrusts the auctioneer to reward the bidder greatly attracts the bidder to participate in the bidding, and the starting price is the auction reserve price or the base price, thereby being conducive to improving the auction transaction rate and reducing the problem that the auction target fails to be sold, and the hammer price is increased on this basis, which maximizes the interest of the principal;
2. in the auction process, equivalence or a certain proportion of auction margin of the bidder is temporarily frozen in each bidding, and an auction can be completed at any price after the starting price, thereby guaranteeing the fairness of the auction and the authenticity of the hammer price to the maximum extent, reducing the malicious collusion behaviors between the auctioneers and a particular bidder, between the bidders and the bidders, and between the principal and the auctioneers, so that the auction is fairer, and the auction result is more real, which maximizes the interest of the buyer;
3. after the auction is completed, even if the bidder is not the final buyer, the bidder can earn the price difference between buying and selling, thereby attracting the social funds into the auction industry as the identity of the professional speculators to the maximum extent, thus the volume of the auction industry is increased, which maximizes the interests of the auctioneer, the principal and the buyer; and
4. due to the use of the network auction system, every price bidding or price adding of the bidder is recorded by the electronic trading system, and the buyer is required to pay in time, thereby effectively preventing the occurrence of regret of the buyer, maximally reducing the auction disputes, and meanwhile avoiding the loss of state taxes.

Therefore, by the adoption of the method and system of the present invention, the principal rewards the bidder, so that the bidder can enjoy a part of price difference within the bidding increment; as an electronic auction auxiliary system is designed, the auction activity is more transparent and rigorous, and the errors are reduced; and as the equivalence or certain proportion of the auction margin is frozen in each bidding, the interests of the auction parties are maximized, and the auction is opener, fairer, more impartial, more honest and more credible.

### DESCRIPTION OF FIGURES

FIG. 1 is a schematic diagram of the method of the present invention;

FIG. 2 is an operation flowchart of the present invention;

FIG. 3 is a curve chart of a bidding reward algorithm;

FIG. 4 is a working schematic diagram of a bidder;

FIG. 5 is a working schematic diagram of a principal;

FIG. 6 is a working schematic diagram of an auction system platform;

FIG. 7 is a network structure diagram of an auction system;

FIG. 8 is a design architecture diagram of an auction system;

FIG. 9 is a module structure diagram of an auction system;

FIG. 10 is an interface diagram of the auction system;

FIG. 11 is an interface diagram of a handheld terminal of the auction system.

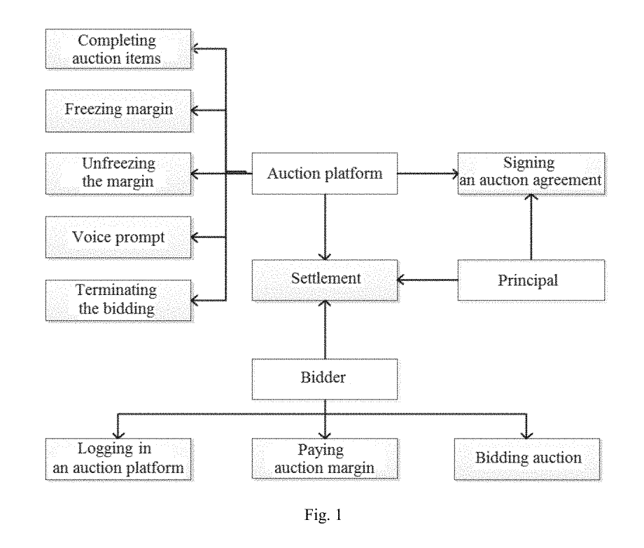

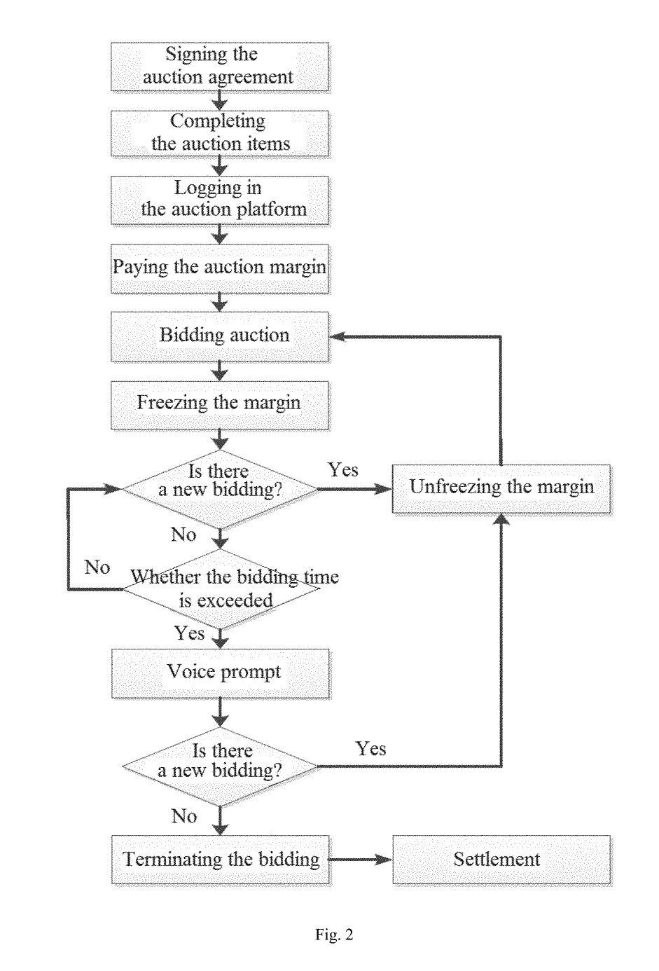

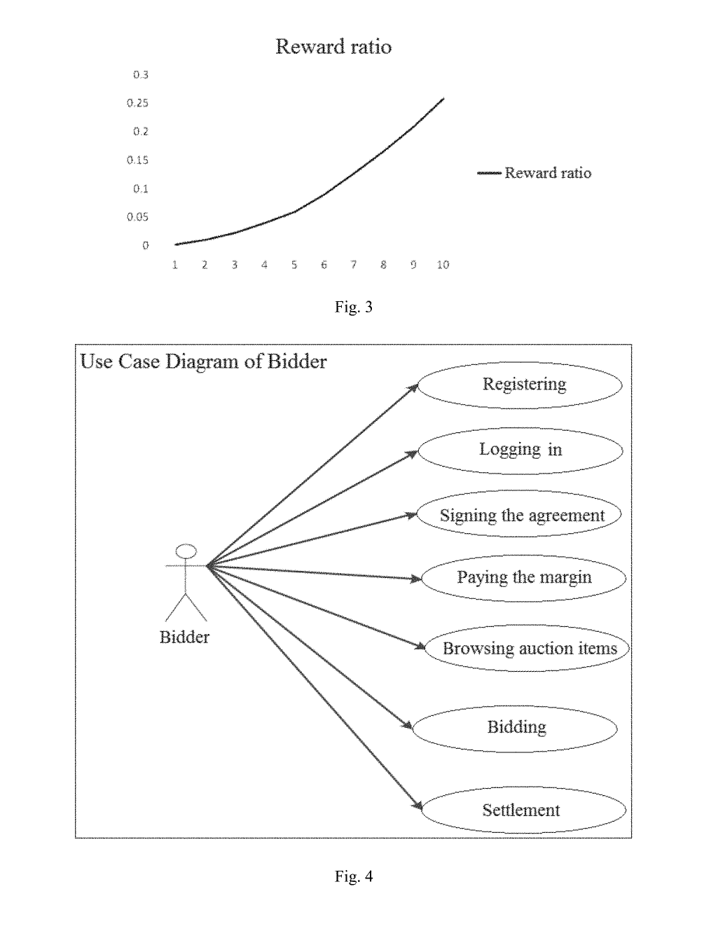

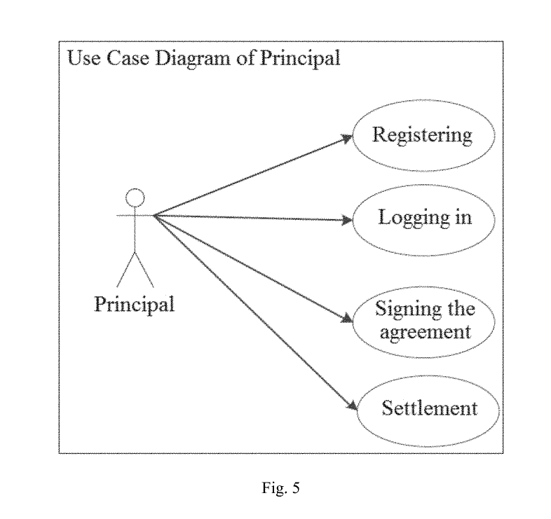

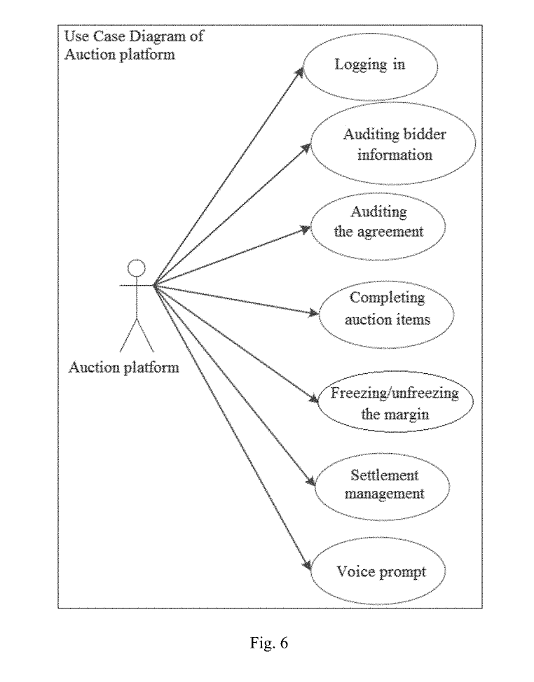

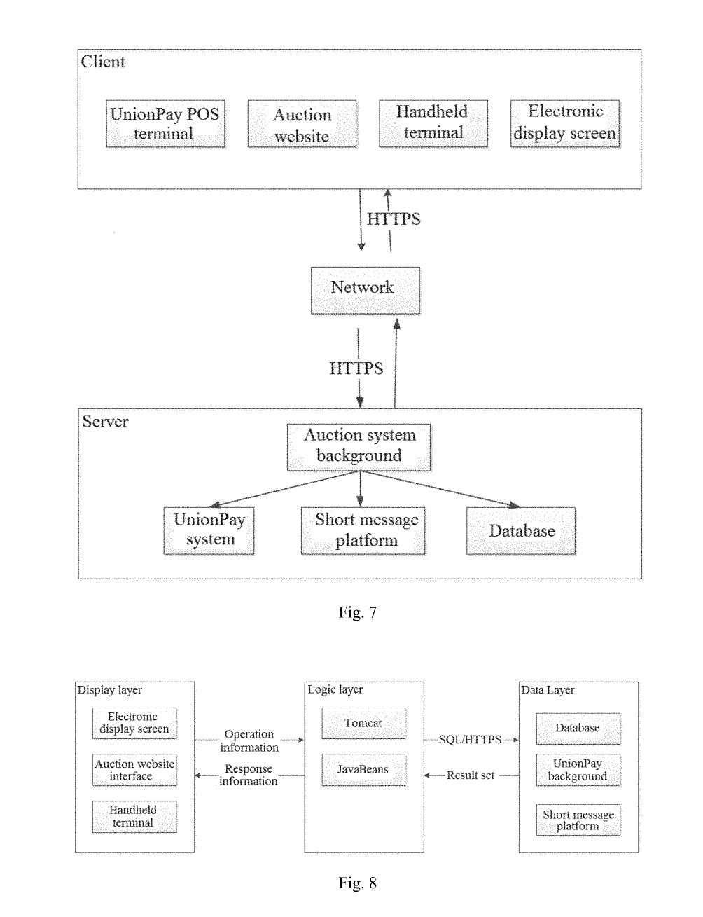

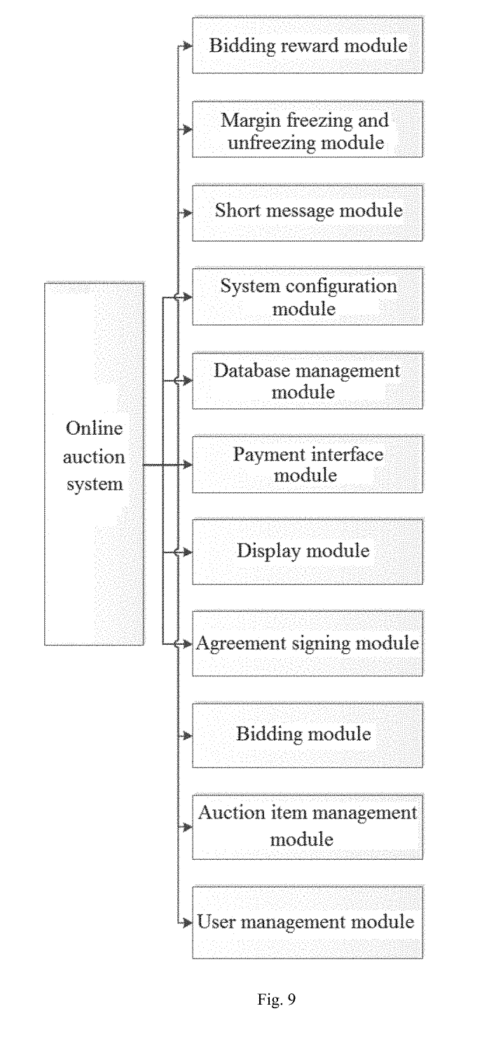

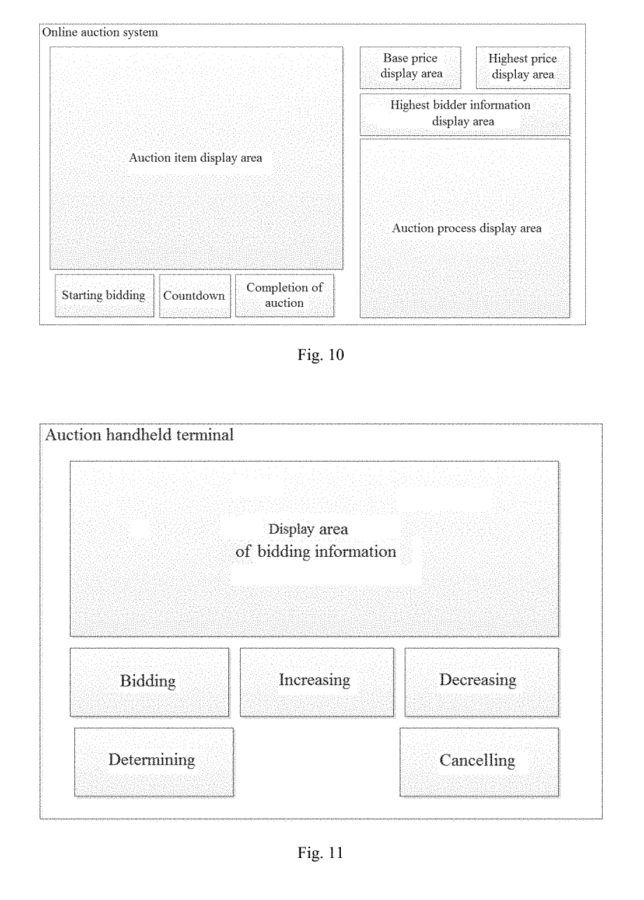

### SPECIFIC MODE FOR CARRYING OUT THE INVENTION

A network auction method for establishing a bidding reward mechanism, wherein the bidding reward mechanism is as follows: a principal entrusting an auctioneer to reward bidders so as to enable the bidders to enjoy part of price difference within a bidding increment; and in an auction, an auction platform freezes an equal amount or a certain proportion amount of margin of one bidder when the bidder bids every time, the frozen margin is unfrozen only until a new auctioneer bids, and so on.

In the above technical solution, the network auction method for establishing the bidding reward mechanism specifically comprises:

1) an online network auction system is adopted, the system is implemented by a B/S architecture and is divided into a client and a server, the client comprises a Point of sales terminal, an auction website, a handheld terminal and an electronic display screen, and the server comprises a auction system background server, and a Bank card settlement system, a short message platform and a database, which are connected with the auction system background server; data is transmitted between the client and the server through the network by using an HTTPS protocol;
2) according to the law, the server formulates auction rules and an access system of parties involved in auction, signs agreements between an auctioneer and a principal and between the auctioneer and a bidder, and stores the agreements and the identity information of the principal and the bidder in a database;
the principal applies for a user name and a password through the auction system for checking the transaction condition and reward information of an auction target. The bidder applies for a user name and a password through the auction system for viewing the auction target, knowing the auction situation and participating in the auction;
the auction rules formulated by the server, the agreement signed between the auctioneer and the principal and between the auctioneer and the bidder comprise the bidding reward mechanism: after the completion of the auction of each auction target, the principal entrusts the auctioneer to reward the bidder with premium exceeding an auction reserve price in an hammer price of the auction target according to a certain proportion;
3) the auctioneer releases auction target information, the bidding reward mechanism, the auction time, an auction location, an auction target display manner, an auction target reserve price, a notary organ and other information to the client through the server and the network according to the agreement signed between the principal and the auctioneer, and meanwhile sends auction target bidding information to the bidder in the form of a short message through the short message platform;
4) the bidder can pay a full amount of auction margin to the auction platform through the auction website, or the handheld terminal, or the Bank card settlement system or customer service staff of authorized server within a prescribed time before the start of an auction, or the bidder can pay the auction margin in an auction process so as to guarantee the validity of each bidding of the bidder, and to guarantee that the bidder can pay the full amount of hammer price in time if the bidder becomes the buyer; the bidder obtains a corresponding amount of virtual chips after successfully paying the sufficient auction margin;
when the bidder pays through the auction website or the handheld terminal, the auction website or the handheld terminal prompts the required payment to obtain the bidding permission and other information, bidder inputs user name, payment amount, bank card numbers, bank card passwords and other information in a browser form after confirmation, the client performs 3DES encryption on the information of the browser form and sends the information of the browser form to the auction system background server by using the https protocol, the background server obtains the user name, bank card number ciphertext, password ciphertex, payment amount ciphertext and other information by decrypting the information, then packages all the information into an IS08583 standard message, and sends a payment message to a Bank card settlement system background through a dedicated network of the Bank card settlement system background in the form of a socket message request, the Bank card settlement system background forwards the message to different banks through received bank card bin information and the dedicated networks with the banks to perform a deduction operation, and forwards a success message to the Bank card settlement system, after the deduction operation of the banks are complete, the Bank card settlement system sends the information to the auction system background server and transfers the corresponding amount to a public account of the auction platform through super online bank, the auction system background server inserts deduction information into the database after obtaining the information of successful deduction, authorizes corresponding bidding permission and an auction password to the bidder and then returns the permission information to the client, and the entire margin payment process is ended;
5) the auction is started, the whole process of the auction is displayed on the electronic display screen of the client, the handheld terminal and the page of the auction website, and the auction is carried out on the Internet and/or in an electronic trading hall; the electronic display screen is arranged in the electronic trading hall, the auction target is displayed on the electronic display screen, the handheld terminal and the auction website, after the auction is started, the bidder logs in the auction system and inputs the user name and the password, the browser transmits the ciphertext encrypted by the DES algorithm to the auction system background server through the https protocol, the auction system background server obtains plaintexts of the user name and the password after decrypting the received user name and the password, then inquires the database and compares the user name and the password with the user name and the password in the database, the auction system background server sends a login success command to a bidder browsing interface through the https after the verification is passed, the bidder enters an auction interface to perform a bidding operation, the auction is not limited by territory and can be operated on the Internet, the auction can also be implemented by a computer terminal of the electronic trading hall provided by the auction platform, if the auction is implemented in the electronic trading hall, the electronic display screen in the hall is directly controlled by the auction system background server for display, the latest record in the database is obtained by continuous refreshing, and thus the bidding information and the transaction information are updated and displayed in real time;
6) the bidder continuously performs local refreshing through a client browser to obtain the latest bidding information and transaction records in the database, the latest bidding information and the transaction records are displayed in the user auction interface in real time, the bidder starts to perform a bidding operation through the page operation if he feels that the price is appropriate, if the bidder clicks a “bidding” button on the interface, the system performs DES encryption on user information, the bidding amount and other information according to a preset price of the bidder and submits the information to the auction system background server by the AJAX local refreshing technology, at this time, the auction system background server is in a waiting state and waits for the bidding information of the clients in real time, after the auction system background server receives the first bidding information or the highest bidding information, the auction system background server obtain the information of the user who bids and the bidding amount through character strings parsing, and then performs rule verification on the bidding information, the auction system background server returns a bidding success message to all the online clients after the verification is passed, and all the clients comprising the client of the bidder display the message that the present bidding is successful;
7) every time the bidder bids, the auction platform firstly inquires the corresponding record of the bidder in the database, checks whether the user has corresponding auction margin for the auction operation, and freezes equal funds of bidding or a certain proportion of funds in the auction margin if the virtual chips are sufficient, and the frozen margin is unfrozen only until a new bidder starts bidding, and so on, and the bidder can obtain the bidding records of his own and other bidders from the auction interface in real time;
8) the auction system background server sets up an auction countdown, that is, there is a prescribed time after each bidding of the bidder, for example, the prescribed time can be set as 10 seconds, the electronic system whistles for three times to prompt that the prescribed time has been exceeded, the countdown is transferred to all the clients through the network in real time, if the server receives a certain valid bidding request, the countdown is reset to the initial value, if no bidding request is received when the countdown is ended, the system identifies the last valid bidding information as the transaction information, and then sends the transaction information to all the clients and terminals, and the bidding system temporarily closes the bidding and determines the buyer;
9) according to the bidding reward mechanism in the agreements signed between an auctioneer and a principal and between the auctioneer and a bidder, the auction system background server allocates the premium part exceeding the auction reserve price in the hammer price in proportions specified in the agreements to the bidders participating in the bidding in the auction of the auction target after the transaction of each auction target;
10) the auction interfaces of the client and the auction system background server display a transaction record of the bidding process and the information of the buyer, and display the reward amounts obtained by the bidders participating in the bidding; and
11) after the auction is ended, the buyer can pay the transaction amount of the auction and commissions through the website platform and fills in the receipt information and the like; the auction platform returns the auction margins and rewards of other bidders to the personal accounts of the bidders, and the bidders can transfer out balance of the accounts and can also deposit balance of the accounts in the personal accounts of the bidders to serve as the auction margins of the next auction.

According to the network auction method for establishing the bidding reward mechanism, the bidding reward mechanism is as follows: the reward limit is S, the total number of bidding is N, the reward obtained in each bidding is Mn (n=1, 2, . . . , N), the weight of each bidding is an (n=1, 2, . . . , N), Mn=S*an (n=1, 2, . . . , N), wherein

$$an = ( n * n ) / {\sum }_{i = 1}^{N} ( i * i ) ( n = 1 , 2 , . . . , N ) ,$$

the rule is open to all the users through the website, an administrator of the auction system background server adds the above algorithm to the system server.

According to the network auction method for establishing the bidding reward mechanism, wherein in the bidding reward mechanism, the bidder is rewarded according to a certain proportion of the premium part, the certain proportion is specified by the agreement signed between the principal and the auctioneer.

A network auction system for establishing the bidding reward mechanism, the system is implemented by a B/S architecture and is divided into a client and a server, and the client comprises a Point of sales terminal, an auction website, a handheld terminal and an electronic display screen; the server comprises a auction system background server, and a Bank card settlement system, a short message platform and a database, which are connected with the auction system background server; data is transmitted between the client and the server through the network by using an HTTPS protocol; the client mainly provides user registration, user browsing, auction target information check, auction participation and other functions, and meanwhile can provide bank card brushing, online deduction interface and electronic display screen functions; the server is mainly used for processing foreground data requests, interacting with the database and docking with the Bank card settlement system and the like; the system adopts a three-layer structural design, the electronic display screen, the auction website and the mobile phone terminal are display layers, Tomcst and JavaBeans are logical layers, the database, the Bank card settlement system and the short message platform are data layers, in the three-layer structure, the JSP is responsible for page layout, operation and display, the JavaBean is responsible for packaging service logic, and thus the maintainability and scalability of the system are improved; the system adopts the advanced AJAX technology to submit data without refreshing, thereby relieving the burden of the server and accelerating the submission speed, data transmission is implemented by using the HTTPS protocol which has the highest safety coefficient, the key data are also encrypted and decrypted by using the 3DES algorithm, thereby having certain beneficial effects on the data confidentiality, data integrity and identity reliability; the system comprises: a user management module, an auction target management module, a bidding module, an agreement signing module, a display module, a payment interface module, a database management module, a system configuration module and a short message module; the system is further provided with a margin freezing and unfreezing module and a bidding reward module, the margin freezing and unfreezing module implements the following operations in an auction process: every time the bidder bids, the auction system platform firstly inquires the corresponding record of the bidder in the database, checks whether the user has corresponding virtual chips for the auction operation, and freezes chips, which is equal to or accounts for a certain proportion of bidding, in the virtual chips if the virtual chips are sufficient, and the frozen chips are unfrozen only until a new bidder starts bidding; and the bidding reward module implements the following operations: after the completion of the auction of each auction target, the principal entrusts the auctioneer to reward the bidder with the premium exceeding an auction reserve price in an hammer price of the auction target according to a proportion specified in the agreement.

The present invention mainly has three substantive distinguishing features:

1. the principal rewards the bidder, so that the bidder is able to enjoy a part of price difference within the bidding increment; 2. as an electronic auction auxiliary system is designed, the auction is more transparent and rigorous, and the errors are reduced; and
3. as the equivalence or the corresponding proportion of the auction margin is frozen in each bidding, the interests of the auction parties are maximized, and the auction is opener, fairer, more impartial, more honest and more credible.
The basic demands of the four auction parties in the existing auction activities:
1. the principal: implementing the liquidation of the auction target with the reserve price or base price; and hoping that the hammer price is higher than the reserve price or the base price as much as possible on the basis of the liquidation;
2. the auctioneer: collecting commissions from both parties; and making the hammer price be higher than the reserve price or the base price as much as possible so as to increase the commission income;
3. the bidder: becoming the buyer through the bidding behavior; that is to say, when no other bidder bids or adds the price, the bidder becomes the buyer; when the other bidders bid or add the price, the bidder serves as a seller, because the subsequent bidders bid or add the price on the basis of the bidding or price adding of the previous bidder, which can be deemed as helping the previous bidder to accomplish the selling behavior; and
4. the buyer: finally becoming the buyer through the bidding behavior of offering the highest price, namely having the responsibility and duty of paying the hammer price of the auction target and having the right of obtaining the auction target.
In the existing auction activity, the premium exceeding the auction reserve price is entirely owned by the principal and has nothing to do with the bidders. However, because the principal has no right to participate in the bidding, the bidding behavior among the bidders can be regarded as bargaining of the buyers and sellers again and again. With respect to the so-called technical innovation of the auction activity, firstly, the indispensable role of the bidders to the auction and the hammer price must be clarified, and the bidders should obtain a part of rewards of the price difference generated by the bidding behavior.

Specifically, it is an innovation of the existing auction form, a network bidding auxiliary way is adopted, so that the auction process is more transparent and rigorous, and the hammer price exceeds the auction reserve price as much as possible on the premise of improving the transaction rate. Because in this process, the bidders play a vital role, the principal entrusts the auctioneer to reward the bidders with the premium exceeding the auction reserve price according to a certain proportion, and thus the bidders obtain a part of rewards of the price difference generated by the bidding behavior.

The actual flows of the auction activity of the present invention after innovation are as follows:

1. the bidder pays enough auction margin to ensure the validity of each bidding of the bidder and to ensure that the bidder has the ability of paying all or a proportion of the hammer price or deposit;
2. the auction activity is implemented in the electronic trading hall, the electronic display screen is arranged in the electronic trading hall, the bidder places an order through a computer, thereby replacing the existing bidding manners that the auctioneer offers and the bidder lifts a number plate;
3. the auction is started, the bidder starts to perform price bidding or bidding, and virtual chips, which is equal to or accounts for a certain proportion of the price bidding or bidding, in the auction margin are frozen in each bidding until the new bidder starts to perform price bidding or bidding, and so on. The price bidding or bidding and mutual bidding process of the bidder on the computer is synchronously displayed on the terminal;
4. there is a prescribed time after each price bidding or bidding of the bidder for waiting for the new bidder to perform the price bidding or bidding, the electronic commerce system whistles for three times when the prescribed time has been exceeded, and at the same time of the third time whistling, the bidding system is temporarily closed and the bidding is terminated to determine the buyer;
5. the terminal displays a transaction record comprising the bidding process; and
6. if there are multiple targets, the auction is performed according to the above mode in turn.

### Embodiment

Assuming that the bidder gets fifty percent of the reward within the bidding increment, and that the starting price, namely, the reserve price or the base price of a certain target is 10 thousand RMB. The auction is started, the bidder A bids 10 thousand RMB, the bidder B bids 12 thousand RMB, the bidder C bids 15 thousand RMB, and the bidder D bids 19 thousand RMB. Then, the electronic commerce system whistles for three times if the prescribed time has been exceeded, and at the same time of the third time whistling, the bidding system is temporarily closed to terminate the bidding, and the bidding system confirms that the bidder D becomes the buyer at the highest bidding of 19 thousand RMB. The price bidding or bidding or bidding conditions of all the bidders are displayed on the terminal, and the transaction record comprising the bidding process is displayed.

Then, the buyer D pays 19 thousand RMB to the auctioneer, among the 19 thousand RMB: the principal obtains 14.5 thousand RMB, the bidder A can only obtain 0 RMB because his bidding is not higher than the auction reserve price or the base price, the bidder B obtains 1 thousand RMB, the bidder C obtains 1.5 thousand RMB, the bidder D obtains 2 thousand RMB, and the principal, the bidder B, the bidder C, the bidder D and the buyer D respectively pay commissions to the auctioneer as contracted.

1. A network auction method for establishing a bidding reward mechanism, wherein the bidding reward mechanism is as follows: a principal entrusting an auctioneer to reward bidders so as to enable the bidders to enjoy part of price difference within a bidding increment; an auction platform freezes an equal amount or a certain percentage amount of margin of one bidder when the bidder bids every time, the frozen margin is unfrozen only until a new auctioneer bids, and so on.

2. The network auction method for establishing the bidding reward mechanism of claim 1, wherein the network auction method for establishing the bidding reward mechanism specifically comprising:
1) an online network auction system is adopted, the system is implemented by a B/S architecture and is divided into a client and a server, the client comprises a Point of sales terminal, an auction website, a handheld terminal and an electronic display screen, and the server comprises a auction system background server, and a Bank card settlement system, a short message platform and a database, which are connected with the auction system background server; data is transmitted between the client and the server through the network by using an HTTPS protocol;
2) according to the law, the server formulates auction rules and an access system of parties involved in auction, signs agreement between an auctioneer and a principal and between the auctioneer and a bidder, and stores the agreements and the identity information of the principal and the bidder in a database;
the principal applies for a user name and a password through the auction system for checking the transaction condition and reward information of an auction target, the bidder applies for a user name and a password through the auction system for checking the auction target, mastering the auction situation and participating in the auction;
the auction rules formulated by the server, the agreement signed between the auctioneer and the principal and between the auctioneer and the bidder comprise the bidding reward mechanism: after the completion of the auction of each auction target, the principal entrusts the auctioneer to reward the bidder with premium exceeding an auction reserve price in an hammer price of the auction target according to a certain proportion;
3) the auctioneer releases auction target information, the bidding reward mechanism, the auction time, an auction location, an auction target display manner, an auction target reserve price, a notary organ and other information to the client through the server and the network according to the agreement signed between the principal and the auctioneer, and meanwhile sends auction target bidding information to the bidder in the form of a short message through the short message platform;
4) the bidder can pay a full amount of auction margin to the auction platform through the auction website, or the handheld terminal, or the Bank card settlement system or customer service staff of authorized server within a prescribed time before the start of an auction, and the bidder can pay the auction margin in an auction process so as to guarantee the validity of each bidding of the bidder, and to guarantee that the bidder can pay the full amount of hammer price in time if the bidder becomes the buyer; the bidder obtains a corresponding amount of virtual chips after successfully paying sufficient auction margin;
when the bidder pays through the auction website or the handheld terminal, the auction website or the handheld terminal prompts the required payment to obtain the bidding permission and other information, bidder inputs user name, payment amount, bank card numbers, bank card passwords and other information in a browser form after confirmation, the client performs 3DES encryption on the information of the browser form and sends the information of the browser form to the auction system background server by using the https protocol, the background server obtains the user name, bank card number ciphertext, password ciphertex, payment amount ciphertext and other information by decrypting the information, then packages all the information into an IS08583 standard message, and sends a payment message to a Bank card settlement system background through a dedicated network of the Bank card settlement system background in the form of a socket message request, the Bank card settlement system background forwards the message to different banks through received bank card bin information and the dedicated networks with the banks to perform a deduction operation, and forwards a success message to the Bank card settlement system after the deduction operation of the banks are complete, the Bank card settlement system sends the information to the auction system background server and transfers the corresponding amount to a public account of the auction platform through super online bank, the auction system background server inserts deduction information into the database after obtaining the information of successful deduction, authorizes corresponding bidding permission and an auction password to the bidder and then returns the permission information to the client, and the entire margin payment process is ended;
5) the auction is started, the whole process of the auction is displayed on the electronic display screen of the client, the handheld terminal and the page of the auction website, and the auction is carried out on the Internet and/or in an electronic trading hall; the electronic display screen is arranged in the electronic trading hall, the auction target is displayed on the electronic display screen, the handheld terminal and the auction website, after the auction is started, the bidder logs in the auction system and inputs the user name and the password, the browser transmits the ciphertext encrypted by the DES algorithm to the auction system background server through the https protocol, the auction system background server obtains plaintexts of the user name and the password after decrypting the received user name and the password, then inquires the database and compares the user name and the password with the user name and the password in the database, the auction system background server sends a login success command to a bidder browsing interface through the https after the verification is passed, the bidder enters an auction interface to perform a bidding operation, the auction is not limited by territory and can be operated on the Internet, the auction can also be implemented by a computer terminal of the electronic trading hall provided by the auction platform, if the auction is implemented in the electronic trading hall, the electronic display screen in the hall is directly controlled by the auction system background server for display, the latest record in the database is obtained by continuous refreshing, and thus the bidding information and the transaction information are updated and displayed in real time;
6) the bidder continuously performs local refreshing through a client browser to obtain the latest bidding information and transaction records in the database, the latest bidding information and the transaction records are displayed in the user auction interface in real time, the bidder starts to perform a bidding operation through the page operation if he feels that the price is appropriate, if the bidder clicks a “bidding” button on the interface, the system performs DES encryption on user information, the bidding amount and other information according to a preset price of the bidder and submits the information to the auction system background server by the AJAX local refreshing technology, at this time, the auction system background server is in a waiting state and waits for the bidding information of the clients in real time, after the auction system background server receives the first bidding information or the highest bidding information, the auction system background server obtain the information of the user who bids and the bidding amount through character strings parsing, and then performs rule verification on the bidding information, the auction system background server returns a bidding success message to all the online clients after the verification is passed, and all the clients comprising the client of the bidder display the message that the present bidding is successful;
7) every time the bidder bids, the auction platform firstly inquires the corresponding record of the bidder in the database, checks whether the user has corresponding auction margin for the auction operation, and freezes equal funds of bidding or a certain proportion of funds in the auction margin if the virtual chips are sufficient, and the frozen margin is unfrozen only until a new bidder starts bidding, and so on, and the bidder can obtain the bidding records of his own and other bidders from the auction interface in real time;
8) the auction system background server sets up an auction countdown, that is, there is a prescribed time after each bidding of the bidder, for example, the prescribed time can be set as 10 seconds, the electronic system whistles for three times to prompt that the prescribed time has been exceeded, the countdown is transferred to all the clients through the network in real time, if the server receives a certain valid bidding request, the countdown is reset to the initial value, if no bidding request is received when the countdown is ended, the system identifies the last valid bidding information as the transaction information, and then sends the transaction information to all the clients and terminals, and the bidding system temporarily closes the bidding and determines the buyer;
9) according to the bidding reward mechanism in the agreements signed between an auctioneer and a principal and between the auctioneer and a bidder, the auction system background server allocates the premium part exceeding the auction reserve price in the hammer price in proportions specified in the agreements to the bidders participating in the bidding in the auction of the auction target after the transaction of each auction target;
10) the auction interfaces of the client and the auction system background server display a transaction record of the bidding process and the information of the buyer, and display the reward amounts obtained by the bidders participating in the bidding; and
11) after the auction is ended, the buyer can pay the transaction amount of the auction and commissions through the website platform and fills in the receipt information and the like; the auction platform returns the auction margins and rewards of other bidders to the personal accounts of the bidders, and the bidders can transfer out balance of the accounts and can also deposit balance of the accounts in the personal accounts of the bidders to serve as the auction margins of the next auction.

3. The network auction method for establishing the bidding reward mechanism of claim 1, wherein the bidding reward mechanism is as follows: the reward limit is S, the total number of bidding is N, the reward obtained in each bidding is Mn (n=1, 2, . . . , N), the weight of each bidding is an (n=1, 2, . . . , N), Mn=S*an (n=1, 2, . . . , N), wherein
$$an = ( n * n ) / {\sum }_{i = 1}^{N} ( i * i ) ( n = 1 , 2 , . . . , N ) ,$$
the rule is open to all the users through the website, an administrator of the auction system background server adds the above algorithm to the system server.

4. The network auction method for establishing the bidding reward mechanism of claim 1, wherein in the bidding reward mechanism, the bidder is rewarded according to a certain proportion of the premium part, and the certain proportion is specified by the agreement signed between the principal and the auctioneer.

5. A network auction system for establishing a bidding reward mechanism, the system is implemented by a B/S architecture and is divided into a client and a server, and the client comprises a Point of sales terminal, an auction website, a handheld terminal and an electronic display screen; the server comprises an auction system background server, and a Bank card settlement system, a short message platform and a database, which are connected with the auction system background server; data is transmitted between the client and the server through the network by using an HTTPS protocol; the client mainly provides user registration, user browsing, auction target information check, auction participation and other functions, and meanwhile can provide bank card brushing, online deduction interface and electronic display screen functions; the server is mainly used for processing foreground data requests, interacting with the database and docking with the Bank card settlement system and the like; the system adopts a three-layer structural design, the electronic display screen, the auction website and the mobile phone terminal are display layers, Tomcst and JavaBeans are logical layers, the database, the Bank card settlement system and the short message platform are data layers, in the three-layer structure, the JSP is responsible for page layout, operation and display, the JavaBean is responsible for packaging service logic, and thus the maintainability and scalability of the system are improved; the system adopts the advanced AJAX technology to submit data without refreshing, thereby relieving the burden of the server and accelerating the submission speed, data transmission is implemented by using the HTTPS protocol which has the highest safety coefficient, key data are also encrypted and decrypted by using the 3DES algorithm, thereby having certain beneficial effects on the data confidentiality, data integrity and identity reliability; the system comprises: a user management module, an auction target management module, a bidding module, an agreement signing module, a display module, a payment interface module, a database management module, a system configuration module and a short message module; wherein the system is further provided with a margin freezing and unfreezing module and a bidding reward module, the margin freezing and unfreezing module implements the following operations in an auction process: every time the bidder bids, the auction system platform firstly inquires the corresponding record of the bidder in the database, checks whether the user has corresponding virtual chips for the auction operation, and freezes chips, which is equal to or accounts for a certain proportion of bidding, in the virtual chips if the virtual chips are sufficient, and the frozen chips are unfrozen only until a new bidder starts bidding; and the bidding reward module implements the following operations: after the completion of the auction of each auction target, the principal entrusts the auctioneer to reward the bidder with the premium exceeding an auction reserve price in an hammer price of the auction target according to a proportion specified in the agreement.

6. The network auction method for establishing the bidding reward mechanism of claim 2, wherein the bidding reward mechanism is as follows: the reward limit is S, the total number of bidding is N, the reward obtained in each bidding is Mn (n=1, 2, . . . , N), the weight of each bidding is an (n=1, 2, . . . , N), Mn=S*an (n=1, 2, . . . , N), wherein (n=1, 2, . . . , N), the rule is open to all the users through the website, an administrator of the auction system background server adds the above algorithm to the system server.
